(19) United States
(12) Patent Application Publication
(10) Pub. No.: US 2026/0062343 A1
(43) Pub. Date: Mar. 5, 2026

(54) MULTIFUNCTIONAL PROTECTIVE COATING AND PREPARATION METHOD THEREFOR, AND COATED PRODUCT AND USE

(71) Applicant: VITALINK INDUSTRY (SHENZHEN) CO., LTD., Shenzhen (CN)

(72) Inventors: Wei Wang, Shenzhen (CN); Feng Huang, Shenzhen (CN); Zhu Yan, Shenzhen (CN); Zhi Tan, Shenzhen (CN); Jiamin Liang, Shenzhen (CN)

(21) Appl. No.: 19/380,941

(22) Filed: Nov. 5, 2025

Related U.S. Application Data
(63) Continuation-in-part of application No. PCT/CN2023/143463, filed on Dec. 29, 2023.

(30) Foreign Application Priority Data
Aug. 14, 2023 (CN) 202311020538.4

(51) Int. Cl. C03C 17/22; C09D 1/00

(52) U.S. Cl. CPC C03C 17/225; C09D 1/00; C03C 2217/281; C03C 2217/78; C03C 2218/156

(57) ABSTRACT

Provided are a multifunctional protective coating, a preparation method, a coated product, and an application thereof. The multifunctional protective coating contains a material with the chemical formula SiₓN_{y}, where the material satisfies the following characteristics: (a) x and y are atomic ratios, with 0.39≤x≤0.43 and 0.57≤y≤0.61; (b) a full width at half maximum (FWHM) of a Fourier Transform Infrared (FTIR) spectrum at a peak position range of 838˜875 cm⁻¹ is 247˜313 cm⁻¹; (c) a refractive index at 550 nm is 2.0˜2.2; and (d) the hydrogen content, by the atomic percentage, is ≤1%. The multifunctional protective coating combines high refractive index, high nano-hardness, high scratch resistance, low stress, and high durability.

### CROSS-REFERENCE TO RELATED APPLICATIONS

The present application is a continuation-in-part application of PCT application No. PCT/CN2023/143463 filed on Dec. 29, 2023, which claims the benefit of claims the priority to the Chinese patent application with the filling No. 202311020538.4 filed with the Chinese Patent Office on Aug. 14, 2023, and entitled “MULTIFUNCTIONAL PROTECTIVE COATING AND PREPARATION METHOD THEREFOR, AND COATED PRODUCT AND APPLICATION THEREOFUSE”. The contents of the above identified applications are incorporated herein by reference in entirety.

### TECHNICAL FIELD

The present disclosure relates to the technical field of coating protection, and specifically to a multifunctional protective coating, a preparation method, a coated product, and use.

### BACKGROUND

3C products, which refer to computer, communication, and consumer electronic products, are also known as “information appliances”, such as computers, tablets, mobile phones, or digital audio players. Since 3C products are generally small in size, they are often referred to with the addition of the word “small”, hence commonly termed as “3C small appliances”.

In the selection for hardware materials for 3C products, such as cover panel materials, glass or plastic products, due to their lower cost and lighter texture, have gradually become the main cover panel raw materials for 3C products. However, due to the characteristics of glass or plastic materials, which are mainly low hardness, high brittleness, and material being transparent, various protective coatings suitable for glass or plastic surfaces have been developed. With the development of science and technology, the technological content in 3C products has gradually increased. The requirements for protective coatings on glass or plastic surfaces are becoming increasingly high, specifically in terms of high refractive index, high scratch resistance, high hardness, and high durability. Existing research mainly focuses on a single characteristic direction of silicon nitride (SiN) coatings, for example, existing disclosed research often focuses on the refractive index parameters of SiN coatings while neglecting properties such as hardness, scratch resistance, stress, and durability. Current scientific research on SiN coatings that simultaneously meet multi-functional requirements, specifically those with high hardness, high refractive index, high scratch resistance, low stress, and high durability, is lacking. As technology in 3C products continues to advance, there will inevitably be a demand for protective coatings with multi-functional and high-standard requirements in the future.

Therefore, developing a multifunctional protective coating with a high refractive index, high scratch resistance, high hardness, low stress, and high durability is of significant importance.

### SUMMARY

One objective of the present disclosure is to provide a multifunctional protective coating that combines high refractive index, high scratch resistance, high nano-hardness, low stress, and high durability.

Another objective of the present disclosure is to provide a preparation method for the multifunctional protective coating.

Yet another objective of the present disclosure is to provide use of the multifunctional protective coating in coated products.

Still another objective of the present disclosure is to provide a coated product that includes the multifunctional protective coating.

To achieve the above objectives of the present disclosure, on one hand, the present disclosure provides a multifunctional protective coating containing a material with the chemical formula SiₓN_{y}, where the material satisfies the following characteristics:
(a) x and y are atomic ratios, with 0.39≤x≤0.43 and 0.57≤y≤0.61;
(b) the full width at half maximum (FWHM) of the Fourier Transform Infrared (FTIR) spectrum at a peak position range of 838˜875 cm⁻¹ is 247˜313 cm⁻¹;
(c) the refractive index at 550 nm is 2.0˜2.2; and
(d) the hydrogen content, by the atomic percentage, is ≤1%.

In some embodiments, the refractive index at 550 nm is 2.04˜2.13.

In some embodiments, the nano-hardness of the coating ranges from 25 to 30 GPa.

In some embodiments, the thickness of the coating is 0.01˜6.0 μm.

On the other hand, the present disclosure provides a preparation method for a multifunctional protective coating, including the following steps:
depositing the constituent elements of the multifunctional protective coating onto at least a portion of the surface of a substrate by a physical vapor deposition according to a predetermined ratio, to form the multifunctional protective coating.

In some embodiments, the physical vapor deposition is at least one of vacuum evaporation, sputter deposition, arc plasma coating, ion plating, and molecular beam epitaxy.

In some embodiments, the sputter deposition is magnetron sputter deposition. Optionally, it is direct-current (dc) magnetron sputter deposition, radio-frequency magnetron sputter deposition, or direct-current magnetron sputter deposition assisted by a radio-frequency power supply.

In some embodiments, under the condition of introducing a mixed gas of argon gas and a nitrogen-containing gas, a silicon target is used to form the multifunctional protective coating onto at least a portion of the surface of the substrate by sputter deposition.

In some embodiments, the nitrogen-containing gas is the nitrogen gas, and the gas flow ratio of argon gas to nitrogen gas is (0.61˜0.71): 1.

In some embodiments, the preparation method includes at least one of the following characteristics.

The sputter deposition temperature is 30˜330° C.

The total gas pressure of the mixed gas is 0.05˜1.2 Pa.

The nitrogen gas flow rate is 56˜300 sccm.

The power density of the silicon target is 1.5˜2.4 W/cm².

The bias voltage of the substrate is −180 to −20 V.

The sputter deposition time is 10˜300 minutes.

The background pressure of the vacuum chamber used by the sputter deposition is ≤3.0×10⁻³ Pa.

Yet another aspect of the present disclosure provides use of any one of the above multifunctional protective coatings in coated products.

In some embodiments, the multifunctional protective coating is at least a part of the protective coating of the coated product.

Yet another aspect of the present disclosure provides a coated product, including a substrate and any one of the above multifunctional protective coatings.

In some embodiments, the multifunctional protective coating is located on at least one side of the substrate.

In some embodiments, the substrate is at least a bare piece, or a coated piece, of one of glass, plastic, and silicon.

In some embodiments, the coated product includes one or more of the multifunctional protective coatings. Optionally, the coated product also includes a diamond-like carbon coating (DLC coating), or an Anti-Fingerprint coating (AF coating), or both.

The beneficial effects of the present disclosure compared to the prior art are as follows.

(1) The multifunctional protective coating of the present disclosure combines high refractive index, high nano-hardness, high scratch resistance, low stress, and high durability.

(2) The multifunctional protective coating of the present disclosure can be used as a protective coating for coated products. It can be used alone as the protective coating for coated products or in combination with other coatings to impart high refractive index, high nano-hardness, high scratch resistance, low stress, and high durability to the coated products.

(3) The preparation method for the multifunctional protective coating of the present disclosure is simple to operate, has good repeatability, and is suitable for industrial application.

### BRIEF DESCRIPTION OF DRAWINGS

In order to more clearly illustrate the specific embodiments of the present disclosure or the technical solution in the prior art, the drawings required to be used in the description of the specific embodiment or prior art will be briefly introduced as follows. Obviously, the drawings described below are some embodiments of the present disclosure. Those of ordinary skill in the art, without paying creative labor, may also obtain other drawings according to these drawings.

FIG. 1 is a schematic diagram of a device for preparing a multifunctional protective coating according to an embodiment of the present disclosure;

FIG. 2 is an FTIR spectrum of a Si_{0.41}N_{0.59} multifunctional protective coating prepared in Example 1 of the present disclosure;

FIG. 3 is an FTIR spectrum of a Si_{0.39}N_{0.61} multifunctional protective coating prepared in Example 2 of the present disclosure;

FIG. 4 is an FTIR spectrum of a Si_{0.42}N_{0.58} multifunctional protective coating prepared in Example 5 of the present disclosure; and

FIG. 5 is an FTIR spectrum of a Si_{0.36}N_{0.64} multifunctional protective coating prepared in Comparative Example 6 of the present disclosure.

### REFERENCE NUMERALS

| | | |
|---|---|---|
| 1 - vacuum chamber; | 2 - sample stage; | 3 - ion source; |
| 4 - silicon target. | | |

### DETAILED DESCRIPTION OF EMBODIMENTS

The technical solutions of the present disclosure will be clearly and completely described below in connection with the drawings and specific embodiments. However, it will be understood by those skilled in the art that the following described embodiments are a part of the embodiments of the present disclosure and not all of the embodiments; they are only used to illustrate the present disclosure and should not be regarded as limiting the scope of the present disclosure. Based on the embodiments in the present disclosure, all other embodiments obtained by those of ordinary skill in the art without making inventive efforts are within the scope of protection of the present disclosure. Unless specified under particular conditions in the embodiments, standard conditions or conditions recommended by the manufacturer are used. Reagents or instruments not specified by a manufacturer are conventional products that can be commercially obtained.

In the description of the present disclosure, it should be noted that the terms such as “center”, “top”, “bottom”, “left”, “right”, “vertical”, “horizontal”, “inside”, “outside”, etc., indicate a positional or orientational relations as shown in the drawings. These terms are intended only to facilitate and simplify the description of the present disclosure, not to indicate or imply that the device or element referred to must have a particular orientation, nor to be constructed and operated in a particular orientation; and therefore are not to be construed as limiting the present disclosure. In addition, the terms “first”, “second”, and “third” are used only for descriptive purposes and are not to be construed as indicating or implying relative importance.

In the description of the present disclosure, it is important to note that unless otherwise clearly stipulated and limited, the terms “mount”, “interconnect”, and “connect” should be understood in a broad sense, for example, it can be a fixed connection, a detachable connection, or an integral connection; it can be a mechanical connection or an electrical connection; and it can be a direct connection, an indirect connection through an intermediary, or an internal communication between two components. Those of ordinary skill in the art can understand the meanings of the above terms in the present disclosure according to specific situations.

The inventor has found that the refractive index is a parameter in the optical property domain of the coating; the hardness and the scratch resistance are two parameters in the mechanical property domain of the coating; and the stress and the durability are two parameters in the internal growth domain of the coating. The five parameters are distributed across three different property domains, and the parameters constrain each other. Some have a positive correlation, and others have a negative correlation. To achieve a coating with high refractive index, high nano-hardness, high scratch resistance, low stress, and high durability, it is necessary to combine the parameters of the coating from multiple dimensions, so as to find the optimal feature space.

Bulk silicon nitride (SiN) is a strong solid with many desirable properties such as high strength, high wear resistance, and high resistance to corrosive environments. These properties are mainly derived from the three-dimensional network of strong covalent bonds. When used in the form of vapor-deposited films, stoichiometric silicon nitrides turn into an amorphous form, in which the three-dimensional covalent Si—N network and the fundamental structural units are similar to those in the crystalline form, but the long-range order is lost. This amorphous form leads to additional desirable properties-high optical transparency-due to the absence of grain boundaries that scatter light. In this regard, amorphous silicon nitride can be used as a favorable optical coating. Such a favorable situation, however, does not hold for a randomly deposited silicon nitride film, because it is generally nonstoichiometric and may contain a significant amount of hydrogen, which impairs the structural units, and the continuity, of the three-dimensional covalent network. Therefore, a high-quality SiN optical coating requires proper stoichiometry and covalent Si—N network, which include (i) a proper N/Si ratio, (ii) a low hydrogen content, (iii) a high mass density, and (iv) a small distortion of interatomic bonds. These requirements are discussed in the following paragraphs.

Firstly, a proper N/Si ratio is needed for low absorption in the SiN coatings. To achieve a low absorption, the amount of Si—Si bonds in the film should be minimized, which calls for sufficient nitridation during the film deposition. In other words, the nitrogen amount of the SiN coatings should be as close to stoichiometric as possible, i.e., the N/Si atomic ratio close to 4/3.

### (Chemical Composition)

Secondly, the hydrogen content in the coatings should be minimized because the hydrogen atoms are detrimental to both the refractive index and the durability. Hydrogen is a monovalent element, and atomic hydrogen in SiN coatings can form only one primary bond (i.e., covalent Si—H or N—H) on one side, yet weak van der Waals interactions on the other side. In other words, these hydrogen atoms act as a network terminator, and thus reduce the degree of cross-linking in the amorphous Si—N network which, in turn, deteriorate many desirable properties such as high strength and abrasion resistance.

In the present disclosure, the SiN coatings can be categorized into two groups based on the hydrogen content: hydrogen-free and hydrogenated. The hydrogen-free coating does not mean that the coating contains absolutely no hydrogen atoms, but rather that the hydrogen content in the coating, by the atomic percentage, is ≤1%.) When the atomic percentage of hydrogen is greater than 1%, we call the coating hydrogenated.

Thirdly, a higher mass density is favorable when the refractive index, the hardness, and the scratch resistance need to be improved in the SiN coatings. In vapor-deposited hydrogen-free SiN coatings, the mass density reflects the packing efficiency of depositing atoms during the film growth; the denser is the packing of the atoms, the greater is the mass density. Consequently, the SiN coatings exhibit a higher refractive index, a higher nano-hardness, and better scratch resistance.

Last but not the least, the short-range atomic configurations in the densely-packed coatings need to be optimized because an excess distortion of interatomic bonds is detrimental to the long-term durability of the coatings. To densely pack the depositing atoms in a low-temperature vapor deposition process, unstable atomic configurations should be disrupted to fill the voids in the growing layer. Inevitably retained in this far-from-equilibrium process are residual defects and bond straining, causing small deviations from the optimal bond strengths. In this disclosure the distribution of such small deviations is characterized by the full width at half maximum (FWHM) of the Si—N absorption bands in the spectra taken by Fourier Transform Infrared (FTIR) spectroscopy, where the band broadening is considered as composed of a distribution of small shifts in peak positions corresponding to small deviations in the Si—N bond strength.

For example, “Low hydrogen content stoichiometric silicon nitride films deposited by plasma-enhanced chemical vapor deposition, Parsons G N, et. al, J. Appl. Phys., 70 (3): 1553-1560” describes a silicon nitride (SiN) coating deposited by chemical vapor deposition, where its Fourier Transform Infrared (FTIR) spectrum has a peak position of 820-870 cm-1, corresponding to an FWHM of 190-210 cm⁻¹ in the FTIR spectrum. Analysis indicates that this SiN coating is hydrogenated, with noticeable hydrogen absorption peaks in the FTIR spectrum, such as the N—H absorption peak at 3330 cm⁻¹ and the Si—H absorption peak at 2140 cm⁻¹. The N—H content is (1.6˜15)×10²¹/cm³ and the Si—H content is (0.8˜16)×10²¹/cm³, indicating that the hydrogen content by the atomic percentage, is greater than 1%. As mentioned earlier, due to the single-bond structure of hydrogen and its poor thermal stability, hydrogenated coatings tend to undergo quality degradation issues during daily use, which will affect the durability of the coating and make it unsuitable for use as a surface coating for 3C products.

For example, “Properties of Magnetron-Sputtered Silicon Nitride Films, T. Serikawa, et. al, J. Electrochem. Soc., 131 (12): 2928-2933” describes a silicon nitride (SiN) coating primarily designed with a nitrogen-rich composition but with a low refractive index. As discussed earlier, the mass density of the coating is poor. The FTIR peak position is 840 cm⁻¹ and the FWHM is 370 cm⁻¹. The FWHM is relatively large. As noted earlier, this indicates a great distortion in the atomic bonding angle of the coating and a high stress in the coating.

Therefore, to achieve a multifunctional protective coating of the present disclosure with a high refractive index, high nano-hardness, high scratch resistance, low stress, and high durability, it is necessary to precisely quantify and control the feature space of each parameter.

Based on this, on the hand, the present disclosure provides a multifunctional protective coating containing a material with the chemical formula SiₓN_{y}, which satisfies the following characteristics:
(a) x and y are atomic ratios, with 0.39≤x≤0.43 and 0.57≤y≤0.61;
(b) an FWHM of an FTIR spectrum at a peak position range of 838˜875 cm⁻¹ is 247˜313 cm⁻¹;
(c) the refractive index at 550 nm is 2.0˜2.2; and
(d) the hydrogen content, by the atomic percentage, is ≤1%.

The multifunctional protective coating of the present disclosure combines high refractive index, high nano-hardness, high scratch resistance, low stress, and high durability.

In the coating of the present disclosure, the hydrogen content by the atomic percentage, refers to the proportion of the number of hydrogen atoms to the sum of the numbers of silicon atoms, nitrogen atoms, and hydrogen atoms.

The multifunctional protective coating of the present disclosure has a nano-hardness of 25˜30 GPa, and the scratch resistance characteristic satisfies the condition that a single layer can withstand 200 times of abrasion resistance test using steel wool and multiple layers can withstand 3000 times of abrasion resistance test using steel wool. The stress satisfies the condition that it can pass the cross-cut adhesion test. The durability satisfies the condition that it can pass 48 h salt spray tests and 72 h thermal shock tests.

In different embodiments of the present disclosure, the x in SiₓN_{y} can be selected from, but is not limited to, 0.39, 0.40, 0.41, 0.42, 0.43, or any range consisted of any two of these values. The y can be selected from, but is not limited to, 0.57, 0.58, 0.59, 0.60, 0.61, or any range consisted of any two of these values.

In different embodiments of the present disclosure, the FTIR peak position range corresponding to the SiₓN_{y} material can be selected from, but is not limited to, 838 cm⁻¹, 840 cm⁻¹, 845 cm⁻¹, 850 cm⁻¹, 855 cm⁻¹, 860 cm⁻¹, 865 cm⁻¹, 870 cm⁻¹, 875 cm⁻¹, or any range consisted of any two of these values. The FTIR peak position refers to the wave number corresponding to the maximum value of the main absorption peak in the FTIR spectrum of the coating of SiₓN_{y} material.

The FWHM corresponding to the absorption peak in the FTIR peak position range of 838˜875 cm⁻¹ can be selected from, but is not limited to, 247 cm⁻¹, 250 cm⁻¹, 260 cm⁻¹, 270 cm⁻¹, 280 cm⁻¹, 290 cm⁻¹, 300 cm⁻¹, 310 cm⁻¹, 313 cm⁻¹, or any range consisted of any two of these values.

In the present disclosure, conventional instruments and methods in the field can be used to obtain the infrared spectrum of the multifunctional protective coating. The corresponding FWHM can be calculated based on the infrared spectrum. For example, the Thermo Fisher IS50 Fourier transform infrared spectrometer can be used.

In different embodiments of the present disclosure, the refractive index of the coating corresponding to the SiₓN_{y} material at 550 nm can be 2.0, 2.02, 2.04, 2.08, 2.1, 2.12, 2.14, 2.15, 2.18, 2.2, or any range consisted of any two of these values.

In some embodiments, the refractive index at 550 nm is 2.04˜2.13.

In some embodiments, the coating contains zero hydrogen content.

In the present disclosure, whether the coating contains hydrogen can be determined based on the presence of hydrogen-related absorption peaks in the FTIR spectrum. If absorption peaks are present at any one or more positions as the following: 3230˜3430 cm⁻¹, 2040˜2240 cm⁻¹, 1450˜1650 cm⁻¹, and 1050˜1250 cm⁻¹, it indicates that the coating contains hydrogen. If no absorption peaks are present at 3230˜3430 cm⁻¹, 2040˜2240 cm⁻¹, 1450˜1650 cm⁻¹, or 1050˜1250 cm⁻¹, it indicates that the coating does not contain hydrogen or contains hydrogen at ≤1%.

In some embodiments, the thickness of the coating is 0.01˜6.0 μm, optionally 0.27˜1.3 μm, and further optionally 0.3˜0.9 μm.

In different embodiments of the present disclosure, the thickness of the coating can be selected from, but is not limited to, 0.01 μm, 0.02 μm, 0.05 μm, 0.08 μm, 0.1 μm, 0.2 μm, 0.5 μm, 0.8 μm, 1.0 μm, 1.5 μm, 2.0 μm, 2.5 μm, 3.0 μm, 3.5 μm, 4.0 μm, 4.5 μm, 5.0 μm, 5.5 μm, 6.0 μm, or any range consisted of any two of these values.

By controlling the thickness of the coating within the above range, the multifunctional properties of the protective coating can be further enhanced, thereby ensuring high refractive index, high nano-hardness, high scratch resistance, low stress, and high durability.

On the other hand, the present disclosure provides a preparation method for a multifunctional protective coating, including the following steps:
depositing the constituent elements of the multifunctional protective coating onto at least a portion of the surface of a substrate by a physical vapor deposition according to a predetermined ratio, to form the multifunctional protective coating.

By the physical vapor deposition under vacuum conditions, element Si is introduced into the sputtering region and combined with element N The parameters x and y in SiₓN_{y} multifunctional protective coating can be precisely controlled through the Si output power and the nitrogen gas flow rate, thus obtaining a protective coating material that meets the compositional requirements of the present disclosure. The performances of the coating are controlled by adjusting the distortion of interatomic bonds angle in atomic bonding and the mass density of the coating.

Furthermore, chemical vapor deposition typically uses hydrogenated precursors to produce SiN coatings, which introduces hydrogen into the coatings and is difficult to remove. In physical vapor deposition, except for adding hydrogenated reactive gases, hydrogen in the coating mostly comes from chamber residual gases with the background pressure conditions, thereby often appearing as impurities.

In some embodiments, the physical vapor deposition is at least one of vacuum thermal evaporation, sputter deposition, arc evaporation, ion plating, and molecular beam epitaxy.

In some embodiments, the sputter deposition is magnetron sputter deposition. Optionally, it is one of direct-current (dc) magnetron sputter deposition, radio-frequency magnetron sputter deposition, or direct-current magnetron sputter deposition assisted by a radio-frequency power supply.

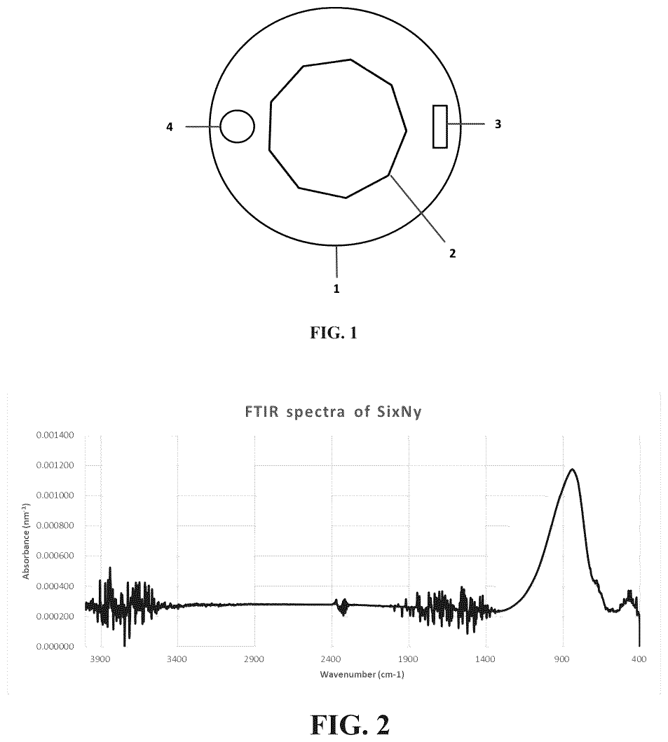

In some embodiments, reference can be made to the schematic diagram of the device for preparing the multifunctional protective coating shown in FIG. 1. The device shown in FIG. 1 includes a vacuum chamber 1, a sample stage 2, an ion source 3, and a silicon target 4, wherein the silicon target 4 can be powered by a pulsed DC power supply, and the pulse duty cycle can be 20%˜90%.

In different embodiments of the present disclosure, the pulse duty cycle can be selected from, but is not limited to, 20%, 30%, 40%, 50%, 60%, 70%, 80%, 90%, or any combination of these values.

In some embodiments, under the condition of introducing a mixed gas of argon gas and a nitrogen-containing gas, a silicon target is used to form the multifunctional protective coating onto at least a portion of the surface of the substrate by sputter deposition.

In some embodiments, the sputter deposition temperature is 30˜330° C., which can be selected from, but is not limited to, 30° C., 40° C., 50° C., 60° C., 70° C., 80° C., 90° C., 100° C., 150° C., 200° C., 250° C., 300° C., 330° C., or any range consisted of any two of these values.

In some embodiments, the sputter deposition time is 10˜300 min, which can be selected from, but is not limited to, 10 min, 20 min, 50 min, 80 min, 100 min, 150 min, 200 min, 250 min, 300 min, or any range consisted of any two of these values. The sputter deposition time is adjusted according to the thickness of the multifunctional protective coating; the longer the sputter deposition time is, the thicker the resulting multifunctional protective coating is. For example, when the deposition time is 110 min, the thickness of the resulting multifunctional protective coating is approximately 0.52 μm.

In some embodiments, the power density of the silicon target is 1.5˜2.4 W/cm², which can be selected from, but is not limited to, 1.5 W/cm², 1.6 W/cm², 1.7 W/cm², 1.8 W/cm², 1.9 W/cm², 2.0 W/cm², 2.1 W/cm², 2.2 W/cm², 2.3 W/cm², 2.4 W/cm², or any range consisted of any two of these values.

In some embodiments, the bias voltage of the substrate is −180 to −20 V, which can be selected from, but is not limited to, −180 V, −150 V, −120 V, −100 V, −80 V, −50 V, −20 V, or any range consisted of any two of these values.

In some embodiments, the background pressure of the vacuum chamber used by the sputter deposition is ≤3.0×10−3 Pa. The background pressure of the vacuum chamber meeting the above conditions can ensure collisions between sputtering particles and gas molecules, and can also reduce the entry of impurities into gas molecules during the deposition process, thereby improving the purity and bonding strength of the multifunctional protective coating material of the present disclosure.

In some embodiments, the total gas pressure of the mixed gas is 0.05˜1.2 Pa, which can be selected from, but is not limited to, 0.05 Pa, 0.1 Pa, 0.2 Pa, 0.5 Pa, 0.8 Pa, 1.0 Pa, 1.2 Pa, or any range consisted of any two of these values.

It can be understood that argon and nitrogen-containing gases can be introduced into the vacuum chamber through a single inlet or mixed in a mixing chamber before entering the chamber, wherein the objective is to reduce the impurity content in the multifunctional protective coating material of the present disclosure and to enhance its performance.

In some embodiments, the nitrogen-containing gas is the nitrogen gas, and the gas flow ratio of argon to nitrogen is (0.61˜0.71):1. By adjusting the gas flow ratio of argon to nitrogen in the mixed gas, the performance of the multifunctional protective coating can be further adjusted.

In different embodiments of the present disclosure, the gas flow ratio of argon gas to nitrogen gas can be selected from, but is not limited to, 0.61:1, 0.62:1, 0.63:1, 0.64:1, 0.65:1, 0.66:1, 0.67:1, 0.68:1, 0.69:1, 0.70:1, 0.71:1, or any range consisted of any two of these values.

In some embodiments, the nitrogen gas flow rate is 56˜300 sccm, which can be selected from, but is not limited to, 56 sccm, 60 sccm, 80 sccm, 100 sccm, 150 sccm, 200 sccm, 250 sccm, 300 sccm, or any range consisted of any two of these values.

In practice, the step of depositing the constituent elements of the multifunctional protective coating onto at least a portion of the surface of a substrate by a physical vapor deposition according to a predetermined ratio, to form the multifunctional protective coating can specifically include the following steps: introducing a mixed gas containing argon gas and nitrogen-containing gas into the vacuum chamber 1 with a background pressure≤3.0×10⁻³ Pa; maintaining the pressure in the vacuum chamber 1 at 0.05˜1.2 Pa; activating the bias voltage and setting to −180 to −20 V; setting the power density of the silicon target 4 to 1.5˜2.4 W/cm²; depositing the SiₓN_{y} coating on at least a portion of the surface of the substrate; and adjusting the sputter deposition time to produce multifunctional protective coatings with different thicknesses.

In some embodiments, before sputtering the multifunctional protective coating onto the substrate, the method further includes a cleaning step for the substrate. The cleaning step can use conventional cleaning methods in the field.

In some embodiments, the cleaning process can include: immersing the substrate in deionized water for ultrasonic cleaning for 3˜15 min, then blowing dry the substrate with nitrogen gas, and placing it onto the sample stage in the vacuum chamber. The sample stage can be a rotatable sample stage.

In some embodiments, after the cleaning process, a single-layer or multi-layer film can be deposited on the substrate surface before depositing the multifunctional protective coating. Whether to pre-deposit and the specific type of single-layer or multi-layer film can be adjusted and selected according to actual needs.

Yet another aspect of the present disclosure provides application of any one of the above multifunctional protective coatings in coated products.

In some embodiments, the multifunctional protective coating is at least a part of the protective coating of the coated product.

In some embodiments, the coated product includes, but is not limited to, 3C products.

Yet another aspect of the present disclosure provides a coated product, including a substrate and any one of the above multifunctional protective coatings.

In some embodiments, the multifunctional protective coating is located on at least one side of the substrate.

In some embodiments, the substrate is at least a bare piece, or a coated piece, of one of glass, plastic, and silicon.

In some embodiments, the coated product includes one or more of the multifunctional protective coatings. Optionally, the coated product also includes a diamond-like carbon coating (DLC coating), or an Anti-Fingerprint coating (AF coating), or both.

The coated products can include only the multifunctional protective coating of the present disclosure, or can additionally include other film layers. The multifunctional protective coating of the present disclosure can be used in conjunction with other film layers.

The testing methods related to the present disclosure are partially as follows.

### 1. Fourier Transform Infrared (FTIR) Spectroscopy

The Thermo Scientific IS50 Fourier transform infrared spectrometer is used, with a double-side polished silicon wafer as the background reference substrate. The absorption spectrum is obtained in the wavelength range of 4000˜400 cm⁻¹ with a wavenumber interval of 0.482 cm⁻¹ and is divided by the film layer thickness for thickness normalization, wherein the peak position is the wavenumber corresponding to the maximum value of the main absorption peak in the absorption spectrum, and the full width at half maximum (FWHM) is the width of the wavenumber range at half the maximum value of the main absorption peak.

### 2. Scratch Resistance Testing Method

A Taber 5750 linear abraser is applied, with a 10×55 mm BRILLIANT steel wool to rub the product surface. The load is set to 250 g, the frequency to 60 times/min, the cycles to 10 times, and the stroke to 15 mm. After the test, it is observed whether there is significant abnormality such as scratches or wear on the product surface.

Rating Levels: Level 1—No damage; Level 2—No obvious scratches visible to the naked eye; Level 3—Few scratches visible to the naked eye; and Level 4—Numerous scratches visible to the naked eye. Judgment Criteria: Level 1 is acceptable, and Levels 2˜4 are unacceptable.

For single layer (SiₓN_{y}), the test is performed 200 times. For multilayer (SiₓN_{y}/DLC/AF), the test is performed 3000 times.

### 3. Durability Testing Method

A high-temperature and high-humidity test machine is applied to conduct a 72 h storage durability test under a environment with a high-temperature of 65° C.±1° C. and a high-humidity of 91%˜95% RH. A thermal shock test machine is applied to conduct a 72 h storage durability test under a temperature cycle environment with a temperature of −40° C.±1° C./1 h˜75° C.±2° C./1 h. A salt spray test machine is applied to conduct a 48 h storage durability test in a salt spray environment with a temperature of 35° C. and a sodium chloride concentration of 5%. After the test, it is observed whether the product coating is intact, the appearance is normal, and the optical performance is normal.

### 4. Stress Testing Method

Stress is characterized by a cross-cut adhesion test. In the present disclosure, the cross-cut adhesion test is based on provisions in the GB/T 9286-2021 standard, with the following method: using a manual single-blade cutter to make 10×10 grids of 1×1 mm on the coated region of the sample surface, applying 3M610 adhesive tape on the cut region, and within 5 min after applying the tape, holding one suspended end of the adhesive tape and peeling the adhesive tape off smoothly at a nearly 60° angle within 0.5 s to 1.0 s. The level is determined according to provisions in the GB/T 9286-2021 standard, where Level 0 indicates pass, and Levels 1˜5 indicate failure.

### 5. Hardness Testing Method

The hardness of each film is tested by a nanoindentation (Model NHT3, Anton-Paar, Austria), which is configured with a tetrahedral Berkovich tip, with an indentation depth set to 100 nm. The load varies with the indentation depth, and after testing 5 matrix points per sample, the average value is taken.

### 6. X-Ray Energy Dispersive Spectroscopy (EDS) for Coating Composition

The x-ray energy dispersive spectrometer adapted to the Regulus 8230 scanning electron microscope manufactured by Hitachi is applied. The relative intensity of all elements is calibrated using the ZAF method. During testing, the electron acceleration voltage is 15 kV, the beam current is 10 μA, and the sample magnification is 200 times. Each sample is tested at 10 points, and the average is taken.

In the embodiment section, “free of hydrogen” means that the coating contains absolutely no hydrogen atoms, or the hydrogen content, by the atomic percentage, is ≤1%.

### Example 1

The present example provides a multifunctional protective coating and a preparation method thereof. The chemical composition of the multifunctional protective coating is Si_{0.41}N_{0.59}. The preparation method includes the following steps.

(1) Pretreatment: placing a high-alumina silicon glass with a dimension of 71×155 mm, a transmittance of T₄₀₀₋₇₀₀=92%, and a pencil hardness of 9H (Corning brand GG3), a PMMA/PC composite board plastic with a pencil hardness of 3H (Mitsubishi brand MB6001UR), and silicon wafer samples with a dimension of 20×20 mm into deionized water for ultrasonic cleaning for 15 min; and after drying with N₂, placing them into the vacuum chamber of the coating machine, and evacuating the vacuum chamber to 3×10⁻³ Pa.

(2) Deposition of the protective coating: turning on the sample stage turntable, setting the rotation speed to 4 cycles per minute, and adjusting the distance between the sample stage and the target surface to 10 cm, wherein the Si target is energized by a pulsed DC power supply; introducing Ar and N₂ gases, setting the N₂ gas flow rate to 60 sccm, and setting the gas flow to maintain a gas flow ratio of Ar gas to N₂ gas of 0.71:1; maintaining the pressure inside the furnace at 0.09 Pa; setting the power density of the Si target to 2.4 W/cm², with a pulse duty cycle of 20%; and depositing the SiN protective coating. By controlling the film-forming time, the resulting film thickness was 291 nm.

The multifunctional protective coating obtained by the above method was Si_{0.41} N_{0.59} and the silicon wafer was conducted on an FTIR spectroscopy, which shows that, as shown in FIG. 2, its FTIR peak position was 838 cm⁻¹, with a corresponding FWHM of 297 cm⁻¹. No hydrogen-related absorption peaks appeared at 3230˜3430 cm⁻¹, 2040˜2240 cm⁻¹, 1450˜1650 cm⁻¹, or 1050˜1250 cm⁻¹, indicating that the coating does not contain hydrogen.

The multifunctional protective coating prepared in the present example has a refractive index of 2.13 at 550 nm. The nano-hardness value of the film layer on the GG3 high-alumina silicon glass substrate was tested to be 30 GPa, and the Mohs hardness level of the film layer on the GG3 high-alumina silicon glass substrate was tested to be 6.

The film layer on the GG3 high-alumina silicon glass substrate was tested with the abrasion resistance test using steel wool and passed 200 times of abrasion resistance test using steel wool.

The film layer on the GG3 high-alumina silicon glass substrate was tested with the cross-cut adhesion test. The surface appearance showed no abnormalities, with smooth and intact cut edges and no coating layer peeling off, which can achieve a Level 0 according to GB/T 9286-2021.

The film layer on the GG3 high-alumina silicon glass substrate and the film layer on the PMMA/PC composite board plastic were conducted on durability testing and passed 72 h high-temperature and high-humidity storage testing, 72 h temperature shock testing, and 48 h salt spray testing.

The above test results show that the protective coating of the present example possesses multifunctional characteristics, including high refractive index, high hardness, scratch resistance, low stress, and high durability.

### Example 2

The present example provides a multifunctional protective coating and a preparation method thereof. The chemical composition of the multifunctional protective coating is Si_{0.39}N_{0.61}. The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples with a dimension of 20×20 mm into deionized water for ultrasonic cleaning for 15 min; and after drying with N₂, placing them into the vacuum chamber of the coating machine, and evacuating the vacuum chamber to 3× 10⁻³ Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar and N₂ gases, setting the N₂ gas flow rate to 60 sccm, and setting the gas flow to maintain a gas flow ratio of Ar gas to N₂ gas of 0.61:1; maintaining the pressure inside the furnace at 0.09 Pa; setting the power density of the Si target to 2.4 W/cm², with a pulse duty cycle of 60%; and depositing the SiN protective coating. By controlling the film-forming time, the resulting film thickness was 273 nm.

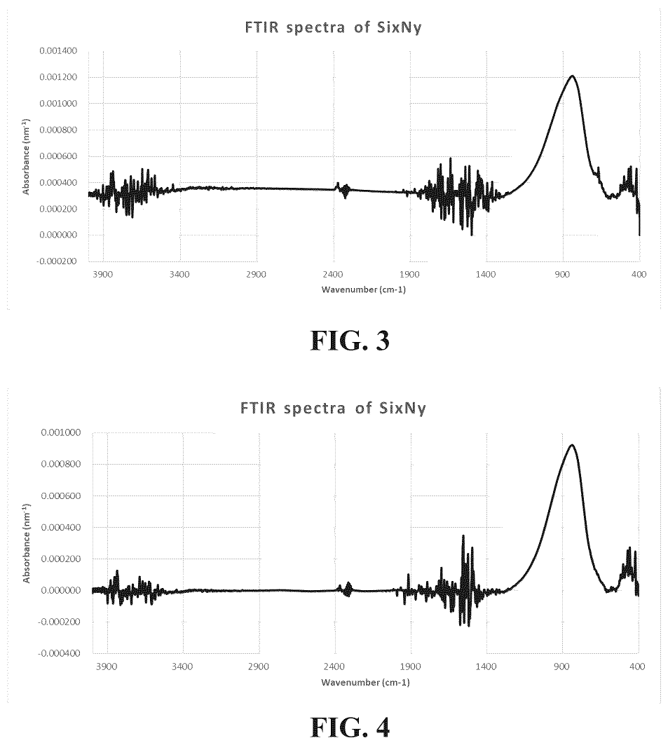

The multifunctional protective coating obtained by the above method was Si_{0.39}N_{0.61} and the silicon wafer was conducted on an FTIR spectroscopy, which shows that, as shown in FIG. 3, its FTIR peak position was 838 cm⁻¹, with a corresponding FWHM of 313 cm⁻¹. No hydrogen-related absorption peaks appeared at 3230˜3430 cm⁻¹, 2040˜2240 cm⁻¹, 1450˜1650 cm⁻¹, or 1050˜1250 cm⁻¹, indicating that the coating does not contain hydrogen.

The multifunctional protective coating prepared in the present example has a refractive index of 2.04 at 550 nm. The nano-hardness value of the film layer on the GG3 high-alumina silicon glass substrate was tested to be 27 GPa, and the Mohs hardness level of the film layer on the GG3 high-alumina silicon glass substrate was tested to be 7.

The film layer on the GG3 high-alumina silicon glass substrate was tested with the abrasion resistance test using steel wool and passed 200 times of abrasion resistance test using steel wool.

The film layer on the GG3 high-alumina silicon glass substrate was tested with the cross-cut adhesion test. The surface appearance showed no abnormalities, with smooth and intact cut edges and no coating layer peeling off, which can achieve a Level 0 according to GB/T 9286-2021 and can pass the cross-cut adhesion test.

The film layer on the GG3 high-alumina silicon glass substrate and the film layer on the PMMA/PC composite board plastic were conducted on durability testing and passed 72 h high-temperature and high-humidity storage testing, 72 h temperature shock testing, and 48 h salt spray testing.

The above test results show that the protective coating of the present example possesses multifunctional characteristics, including high refractive index, high hardness, scratch resistance, low stress, and high durability.

### Example 3

The present example provides a multifunctional protective coating and a preparation method thereof. The chemical composition of the multifunctional protective coating is Si_{0.43}N_{0.57}. The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples with a dimension of 20×20 mm into deionized water for ultrasonic cleaning for 15 min; and after drying with N₂, placing them into the vacuum chamber of the coating machine, and evacuating the vacuum chamber to 3× 10⁻³ Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar and N₂ gases, setting the N₂ gas flow rate to 60 sccm, and setting the gas flow to maintain a gas flow ratio of Ar gas to N₂ gas of 0.67:1; maintaining the pressure inside the furnace at 0.09 Pa; setting the power density of the Si target to 2.4 W/cm², with a pulse duty cycle of 60%; and depositing the Si N protective coating. By controlling the film-forming time, the resulting film thickness was 914 nm.

The multifunctional protective coating obtained by the above method was Si_{0.43}N_{0.57} and the silicon wafer was conducted on an FTIR spectroscopy, which shows that its FTIR peak position was 867 cm⁻¹, with a corresponding FWHM of 288 cm⁻¹. No hydrogen-related absorption peaks appeared at 3230˜3430 cm⁻¹, 2040˜2240 cm⁻¹, 1450˜1650 cm⁻¹, or 1050˜1250 cm⁻¹, indicating that the coating does not contain hydrogen.

The multifunctional protective coating prepared in the present example has a refractive index of 2.08 at 550 nm. The nano-hardness value of the film layer on the GG3 high-alumina silicon glass substrate was tested to be 29 GPa, and the Mohs hardness level of the film layer on the GG3 high-alumina silicon glass substrate was tested to be 6.

The film layer on the GG3 high-alumina silicon glass substrate was tested with the abrasion resistance test using steel wool and passed 200 times of abrasion resistance test using steel wool.

The film layer on the GG3 high-alumina silicon glass substrate was tested with the cross-cut adhesion test. The surface appearance showed no abnormalities, with smooth and intact cut edges and no coating layer peeling off, which can achieve a Level 0 according to GB/T 9286-2021.

The film layer on the GG3 high-alumina silicon glass substrate and the film layer on the PMMA/PC composite board plastic were conducted on durability testing and passed 72 h high-temperature and high-humidity storage testing, 72 h temperature shock testing, and 48 h salt spray testing.

The above test results show that the protective coating of the present example possesses multifunctional characteristics, including high refractive index, high hardness, scratch resistance, low stress, and high durability.

### Example 4

The present example provides a multifunctional protective coating and a preparation method thereof. The chemical composition of the multifunctional protective coating is Si_{0.40}N_{0.60.} The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples with a dimension of 20×20 mm into deionized water for ultrasonic cleaning for 15 min; and after drying with N₂, placing them into the vacuum chamber of the coating machine, and evacuating the vacuum chamber to 3× 10⁻³ Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar and N₂ gases, setting the N₂ gas flow rate to 63 sccm, and setting the gas flow to maintain a gas flow ratio of Ar gas to N₂ gas of 0.61:1; maintaining the pressure inside the furnace at 0.09 Pa; setting the power density of the Si target to 2.4 W/cm², with a pulse duty cycle of 60%; and depositing the Si N protective coating. By controlling the film-forming time, the resulting film thickness was 284 nm.

The multifunctional protective coating obtained by the above method was Si_{0.40}N_{0.60} and the silicon wafer was conducted on an FTIR spectroscopy, which shows that its FTIR peak position was 839 cm⁻¹, with a corresponding FWHM of 248 cm⁻¹. No hydrogen-related absorption peaks appeared at 3230˜3430 cm⁻¹, 2040˜2240 cm⁻¹, 1450˜1650 cm⁻¹, or 1050˜1250 cm⁻¹, indicating that the coating does not contain hydrogen.

The multifunctional protective coating prepared in the present example has a refractive index of 2.04 at 550 nm. The nano-hardness value of the film layer on the GG3 high-alumina silicon glass substrate was tested to be 25 GPa, and the Mohs hardness level of the film layer on the GG3 high-alumina silicon glass substrate was tested to be 7.

The film layer on the GG3 high-alumina silicon glass substrate was tested with the abrasion resistance test using steel wool and passed 200 times of abrasion resistance test using steel wool.

The film layer on the GG3 high-alumina silicon glass substrate was tested with the cross-cut adhesion test. The surface appearance showed no abnormalities, with smooth and intact cut edges and no coating layer peeling off, which can achieve a Level 0 according to GB/T 9286-2021.

The film layer on the GG3 high-alumina silicon glass substrate and the film layer on the PMMA/PC composite board plastic were conducted on durability testing and passed 72 h high-temperature and high-humidity storage testing, 72 h temperature shock testing, and 48 h salt spray testing.

The above test results show that the protective coating of the present example possesses multifunctional characteristics, including high refractive index, high hardness, scratch resistance, low stress, and high durability.

### Example 5

The present example provides a multifunctional protective coating and a preparation method thereof. The chemical composition of the multifunctional protective coating is Si_{0.42}N_{0.58}. The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples with a dimension of 20×20 mm into deionized water for ultrasonic cleaning for 15 min; and after drying with N₂, placing them into the vacuum chamber of the coating machine, and evacuating the vacuum chamber to 3×10⁻³ Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar and N₂ gases, setting the N₂ gas flow rate to 58 sccm, and setting the gas flow to maintain a gas flow ratio of Ar gas to N₂ gas of 0.67:1; maintaining the pressure inside the furnace at 0.09 Pa; setting the power density of the Si target to 2.4 W/cm², with a pulse duty cycle of 60%; and depositing the Si N protective coating. By controlling the film-forming time, the resulting film thickness was 311 nm.

The multifunctional protective coating obtained by the above method was Si_{0.42}N_{0.58} and the silicon wafer was conducted on an FTIR spectroscopy, which shows that, as shown in FIG. 4, its FTIR peak position was 838 cm⁻¹, with a corresponding FWHM of 247 cm⁻¹. No hydrogen-related absorption peaks appeared at 3230˜3430 cm⁻¹, 2040˜2240 cm⁻¹, 1450˜1650 cm⁻¹, or 1050˜1250 cm⁻¹, indicating that the coating does not contain hydrogen.

The multifunctional protective coating prepared in the present example has a refractive index of 2.06 nm at 550 nm. The nano-hardness value of the film layer on the GG3 high-alumina silicon glass substrate was tested to be 26 GPa, and the Mohs hardness level of the film layer on the GG3 high-alumina silicon glass substrate was tested to be 7.

The film layer on the GG3 high-alumina silicon glass substrate was tested with the abrasion resistance test using steel wool and passed 200 times of abrasion resistance test using steel wool.

The film layer on the GG3 high-alumina silicon glass substrate was tested with the cross-cut adhesion test. The surface appearance showed no abnormalities, with smooth and intact cut edges and no coating layer peeling off, which can achieve a Level 0 according to GB/T 9286-2021.

The film layer on the GG3 high-alumina silicon glass substrate and the film layer on the PMMA/PC composite board plastic were conducted on durability testing and passed 72 h high-temperature and high-humidity storage testing, 72 h temperature shock testing, and 48 h salt spray testing.

The above test results show that the protective coating of the present example possesses multifunctional characteristics, including high refractive index, high hardness, scratch resistance, low stress, and high durability.

### Example 6

The present example provides a multifunctional protective coating and a preparation method thereof. The chemical composition of the multifunctional protective coating is Si_{0.41}N_{0.59}. The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples with a dimension of 20×20 mm into deionized water for ultrasonic cleaning for 15 min; and after drying with N₂, placing them into the vacuum chamber of the coating machine, and evacuating the vacuum chamber to 3× 10₋₃ Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar and N₂ gases, setting the N₂ gas flow rate to 60 sccm, and setting the gas flow to maintain a gas flow ratio of Ar gas to N₂ gas of 0.71:1; maintaining the pressure inside the furnace at 0.09 Pa; setting the power density of the Si target to 2.4 W/cm², with a pulse duty cycle of 90%; and depositing the Si N protective coating. By controlling the film-forming time, the resulting film thickness was 1348 nm.

The multifunctional protective coating obtained by the above method was Si_{0.41}N_{0.59} and the silicon wafer was conducted on an FTIR spectroscopy, which shows that its FTIR peak position was 875 cm⁻¹, with a corresponding FWHM of 301 cm⁻¹. No hydrogen-related absorption peaks appeared at 3230˜3430 cm⁻¹, 2040˜2240 cm⁻¹, 1450˜1650 cm⁻¹, or 1050˜1250 cm⁻¹, indicating that the coating does not contain hydrogen.

The multifunctional protective coating prepared in the present example has a refractive index of 2.08 nm at 550 nm. The nano-hardness value of the film layer on the GG3 high-alumina silicon glass substrate was tested to be 28 GPa, and the Mohs hardness level of the film layer on the GG3 high-alumina silicon glass substrate was tested to be 5.

The film layer on the GG3 high-alumina silicon glass substrate was tested with the abrasion resistance test using steel wool and passed 200 times of abrasion resistance test using steel wool.

The film layer on the GG3 high-alumina silicon glass substrate was tested with the cross-cut adhesion test. The surface appearance showed no abnormalities, with smooth and intact cut edges and no coating layer peeling off, which can achieve a Level 0 according to GB/T 9286-2021.

The film layer on the GG3 high-alumina silicon glass substrate and the film layer on the PMMA/PC composite board plastic were conducted on durability testing and passed 72 h high-temperature and high-humidity storage testing, 72 h temperature shock testing, and 48 h salt spray testing.

The above test results show that the protective coating of the present example possesses multifunctional characteristics, including high refractive index, high hardness, scratch resistance, low stress, and high durability.

### Example 7

The present example provides a composite protective coating and a preparation method thereof, including a multifunctional protective coating, a DLC coating, and an AF coating which are arranged in a manner of a stacked deposition, wherein the chemical composition of the multifunctional protective coating is Si_{0.41}N_{0.59}. The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples with a dimension of 20×20 mm into deionized water for ultrasonic cleaning for 15 min; and after drying with N₂, placing them into the vacuum chamber of the coating machine, and evacuating the vacuum chamber to 3×10⁻³ Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar and N₂ gases, setting the N₂ flow rate to 60 sccm, and setting the gas flow to maintain a gas flow ratio of Ar gas to N₂ gas of 0.71:1; maintaining the pressure inside the furnace at 0.09 Pa; setting the power density of the Si target to 2.4 W/cm², with a pulse duty cycle of 20%; and depositing the Si N protective coating, wherein by controlling the film-forming time, the resulting film thickness was 291 nm; then introducing Ar and C₂H₂ gases, setting the C₂H₂ gas flow rate to 400 sccm, setting the gas flow to maintain a flow ratio of Ar gas to C₂H₂ gas of 1:1; maintaining the gas pressure in the furnace at 0.8 Pa, setting the bias voltage duty cycle to 75%; and depositing the DLC coating, wherein by controlling the film-forming time, the resulting film thickness was 20 nm; and finally, using a resistance evaporation source, depositing a 20 nm fingerprint-resistant hydrophobic AF coating by controlling the deposition time.

In the composite protective coating obtained through the aforementioned method, for the multifunctional protective coating Si_{0.41} N_{0.59}, the water contact angle of the composite film layer on the GG3 high-alumina silicon glass substrate was tested to be 115°; the nano-hardness of the composite film layer on the GG3 high-alumina silicon glass substrate was tested to be 25 GPa, with a friction coefficient of 0.16; and the Mohs hardness level of the composite film layer on the GG3 high-alumina silicon glass substrate was tested to be 8.

The composite film layer on the GG3 high-alumina silicon glass substrate was tested with the abrasion resistance test using steel wool and passed 3000 times of abrasion resistance test using steel wool.

The composite film layer on the GG3 high-alumina silicon glass substrate was tested with the cross-cut adhesion test. The surface appearance showed no abnormalities, with smooth and intact cut edges and no coating layer peeling off, which can achieve a Level 0 according to GB/T 9286-2021.

The composite film layer on the GG3 high-alumina silicon glass substrate and the composite film layer on the PMMA/PC composite board plastic were conducted on durability testing and passed 72 h high-temperature and high-humidity storage testing, 72 h temperature shock testing, and 48 h salt spray testing.

The above test results show that the protective coating of the present example possesses multifunctional characteristics, including high refractive index, high hardness, scratch resistance, low stress, and high durability.

### Example 8

The present example provides a composite protective coating and a preparation method thereof, including a multifunctional protective coating, a DLC coating, and an AF coating which are arranged in a manner of a stacked deposition, wherein the chemical composition of the multifunctional protective coating is Si_{0.43}N_{0.57}. The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples with a dimension of 20×20 mm into deionized water for ultrasonic cleaning for 15 min; and after drying with N₂, placing them into the vacuum chamber of the coating machine, and evacuating the vacuum chamber to 3×10⁻³ Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar and N₂ gases, setting the N₂ gas flow rate to 56 sccm, and setting the gas flow to maintain a gas flow ratio of Ar gas to N₂ gas of 0.67:1; maintaining the pressure inside the furnace at 0.09 Pa; setting the power density of the Si target to 2.4 W/cm², with a pulse duty cycle of 60%; and depositing the SiN protective coating, wherein by controlling the film-forming time, the resulting film thickness was 517 nm; then introducing Ar and C₂H₂ gases, setting the C₂H₂ gas flow rate to 400 sccm, setting the gas flow to maintain a flow ratio of Ar gas to C₂H₂ gas of 1:1; maintaining the gas pressure in the furnace at 0.8 Pa, setting the bias voltage duty cycle to 75%; and depositing the DLC coating, wherein by controlling the film-forming time, the resulting film thickness was 20 nm; and finally, using a resistance evaporation source, depositing a 20 nm fingerprint-resistant hydrophobic AF coating by controlling the deposition time.

In the composite protective coating obtained through the aforementioned method, for the multifunctional protective coating Si_{0.43}N_{0.57}, a silicon wafer was conducted on an FTIR spectroscopy, which shows that the FTIR peak position was 848 cm⁻¹, with a corresponding FWHM of 273 cm⁻¹. No hydrogen-related absorption peaks appeared at 3230˜3430 cm⁻¹, 2040˜2240 cm⁻¹, 1450˜1650 cm⁻¹, or 1050˜1250 cm⁻¹, indicating that the coating does not contain hydrogen.

The water contact angle of the composite film layer on the GG3 high-alumina silicon glass substrate was tested to be 114°; the nano-hardness of the composite film layer on the GG3 high-alumina silicon glass substrate was tested to be 23 GPa, with a friction coefficient of 0.17; and the Mohs hardness level of the composite film layer on the GG3 high-alumina silicon glass substrate was tested to be 9.

The composite film layer on the GG3 high-alumina silicon glass substrate was tested with the abrasion resistance test using steel wool and passed 3000 times of abrasion resistance test using steel wool.

The composite film layer on the GG3 high-alumina silicon glass substrate was tested with the cross-cut adhesion test. The surface appearance showed no abnormalities, with smooth and intact cut edges and no coating layer peeling off, which can achieve a Level 0 according to GB/T 9286-2021.

The composite film layer on the GG3 high-alumina silicon glass substrate and the composite film layer on the PMMA/PC composite board plastic were conducted on durability testing and passed 72 h high-temperature and high-humidity storage testing, 72 h temperature shock testing, and 48 h salt spray testing.

The above test results show that the protective coating of the present example possesses multifunctional characteristics, including high refractive index, high hardness, scratch resistance, low stress, and high durability.

### Example 9

The present example provides a composite protective coating and a preparation method thereof, including a multifunctional protective coating, a DLC coating, and an AF coating which are arranged in a manner of a stacked deposition, wherein the chemical composition of the multifunctional protective coating is Si_{0.41} N_{0.59}. The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples with a dimension of 20×20 mm into deionized water for ultrasonic cleaning for 15 min; and after drying with N₂, placing them into the vacuum chamber of the coating machine, and evacuating the vacuum chamber to 3×10⁻³ Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar and N₂ gases, setting the N₂ gas flow rate to 60 sccm, and setting the gas flow to maintain a gas flow ratio of Ar gas to N₂ gas of 0.71:1; maintaining the pressure inside the furnace at 0.09 Pa; setting the power density of the Si target to 2.4 W/cm², with a pulse duty cycle of 90%; and depositing the SiN protective coating, wherein by controlling the film-forming time, the resulting film thickness was 1348 nm; then introducing Ar and C₂H₂ gases, setting the C₂H₂ gas flow rate to 400 sccm, setting the gas flow to maintain a gas flow ratio of Ar gas to C₂H₂ gas of 1:1; maintaining the gas pressure in the furnace at 0.8 Pa, setting the bias voltage duty cycle to 75%; and depositing the DLC coating, wherein by controlling the film-forming time, the resulting film thickness was 20 nm; and finally, by a resistance evaporation source, depositing a 20 nm fingerprint-resistant hydrophobic AF coating by controlling the deposition time.

In the composite protective coating obtained through the aforementioned method, for the multifunctional protective coating Si_{0.41} N_{0.59}, the water contact angle of the composite film layer on the GG3 high-alumina silicon glass substrate was tested to be 115°; the nano-hardness of the composite film layer on the GG3 high-alumina silicon glass substrate was tested to be 26 GPa, with a friction coefficient of 0.17; and the Mohs hardness level of the composite film layer on the GG3 high-alumina silicon glass substrate was tested to be 8.

The composite film layer on the GG3 high-alumina silicon glass substrate was tested with the abrasion resistance test using steel wool and passed 3000 times of abrasion resistance test using steel wool.

The composite film layer on the GG3 high-alumina silicon glass substrate was tested with the cross-cut adhesion test. The surface appearance showed no abnormalities, with smooth and intact cut edges and no coating layer peeling off, which can achieve a Level 0 according to GB/T 9286-2021.

The composite film layer on the GG3 high-alumina silicon glass substrate and the composite film layer on the PMMA/PC composite board plastic were conducted on durability testing and passed 72 h high-temperature and high-humidity storage testing, 72 h temperature shock testing, and 48 h salt spray testing.

The above test results show that the protective coating of the present example possesses multifunctional characteristics, including high refractive index, high hardness, scratch resistance, low stress, and high durability.

### Comparative Example 1

Comparative Example 1 provides a coating and a preparation method thereof. The chemical composition of the coating is Si_{0.36}N_{0.64}. The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples with a dimension of 20×20 mm into deionized water for ultrasonic cleaning for 15 min; and after drying with N₂ gas, placing them into the vacuum chamber of the coating machine, and evacuating the vacuum chamber to 3×10⁻³ Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar and N₂ gases, setting the N₂ gas flow rate to 280 sccm, and setting the gas flow to maintain a flow ratio of Ar gas to N₂ gas of 0.67:1; maintaining the pressure inside the furnace at 0.36 Pa; setting the power density of the Si target to 2.4 W/cm², with a pulse duty cycle of 60%; and depositing the Si N protective coating. By controlling the film-forming time, the resulting film thickness was 240 nm.

The coating obtained by the above method was Si_{0.36}N_{0.64} and the silicon wafer was conducted on an FTIR spectroscopy, which shows that its FTIR peak position was 841 cm⁻¹, with a corresponding FWHM of 351 cm⁻¹. No hydrogen-related absorption peaks appeared at 3230˜3430 cm⁻¹, 2040˜2240 cm⁻¹, 1450˜1650 cm⁻¹, or 1050˜1250 cm⁻¹, indicating that the coating does not contain hydrogen.

The coating prepared in the Comparative Example 1 has a refractive index of 1.96 nm at 550 nm. The nano-hardness value of the film layer on the GG3 high-alumina silicon glass substrate was tested to be 21 GPa, and the Mohs hardness level of the film layer on the GG3 high-alumina silicon glass substrate was tested to be 4.

The coating on the GG3 high-alumina silicon glass substrate was tested with the abrasion resistance test using steel wool and did not pass the test (200-time test result: NG).

The coating on the GG3 high-alumina silicon glass substrate was tested with a cross-cut adhesion test, wherein small debris was observed at the intersection points of the cut lines, the peeled region was less than 5% of the total area, achieving a Level 1 according to GB/T 9286-2021, and the test failed.

The coating on the GG3 high-alumina silicon glass substrate and the coating on the PMMA/PC composite board plastic were conducted on durability testing. After 72 h high-temperature and high-humidity storage testing, 72 h temperature shock testing, and 48 h salt spray testing, the coatings exhibited a certain degree of peeling, and the test failed.

### Comparative Example 2

Comparative Example 2 provides a coating and a preparation method thereof. The chemical composition of the coating is Si_{0.44}N_{0.56}. The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples with a dimension of 20×20 mm into deionized water for ultrasonic cleaning for 15 min; and after drying with N₂, placing them into the vacuum chamber of the coating machine, and evacuating the vacuum chamber to 3×10⁻³ Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar and N₂ gases, setting the N₂ gas flow rate to 240 sccm, and setting the gas flow to maintain a flow ratio of Ar gas to N₂ gas of 0.67:1; maintaining the pressure inside the furnace at 0.34 Pa; setting the power density of the Si target to 2.4 W/cm², with a pulse duty cycle of 60%; and depositing the SiN protective coating. By controlling the film-forming time, the resulting film thickness was 731 nm.

The coating obtained by the above method was Si_{0.44}N_{0.56} and the silicon wafer was conducted on an FTIR spectroscopy, which shows that its FTIR peak position was 859 cm⁻¹, with a corresponding FWHM of 285 cm⁻¹. No hydrogen-related absorption peaks appeared at 3230˜3430 cm⁻¹, 2040˜2240 cm⁻¹, 1450˜1650 cm⁻¹, or 1050˜1250 cm⁻¹, indicating that the coating does not contain hydrogen.

The coating prepared in the Comparative Example 2 has a refractive index of 1.97 nm at 550 nm. The nano-hardness value of the film layer on the GG3 high-alumina silicon glass substrate was tested to be 19 GPa, and the Mohs hardness level of the film layer on the GG3 high-alumina silicon glass substrate was tested to be 3.

The coating on the GG3 high-alumina silicon glass substrate was tested with steel wool and did not pass the test (200-time test result: NG).

The coating on the GG3 high-alumina silicon glass substrate was tested with a cross-cut adhesion test, wherein small debris was observed at the intersection points of the cut lines, the peeled region was less than 5% of the total area, achieving a Level 1 according to GB/T 9286-2021, and the test failed.

The film layer on the GG3 high-alumina silicon glass substrate and the film layer on the PMMA/PC composite board plastic were conducted on durability testing and passed 72 h high-temperature and high-humidity storage testing, 72 h temperature shock testing, and 48 h salt spray testing.

### Comparative Example 3

Comparative Example 3 provides a coating and a preparation method thereof. The chemical composition of the coating is Si_{0.37}N_{0.63}. The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples with a dimension of 20×20 mm into deionized water for ultrasonic cleaning for 15 min; and after drying with N₂, placing them into the vacuum chamber of the coating machine, and evacuating the vacuum chamber to 3× 10⁻³ Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar and N₂ gases, setting the N₂ gas flow rate to 260 sccm, and setting the gas flow to maintain a gas flow ratio of Ar gas to N₂ gas of 0.67:1; maintaining the pressure inside the furnace at 0.36 Pa; setting the power density of the Si target to 2.4 W/cm², with a pulse duty cycle of 60%; and depositing the Si N protective coating. By controlling the film-forming time, the resulting film thickness was 313 nm.

The coating obtained by the above method was Si_{0.37}N_{0.63} and the silicon wafer was conducted on an FTIR spectroscopy, which shows that its FTIR peak position was 843 cm⁻¹, with a corresponding FWHM of 355 cm⁻¹. No hydrogen-related absorption peaks appeared at 3230˜3430 cm⁻¹, 2040˜2240 cm⁻¹, 1450˜1650 cm⁻¹, or 1050˜1250 cm⁻¹, indicating that the coating does not contain hydrogen.

The coating prepared in the Comparative Example 3 has a refractive index of 1.96 nm at 550 nm. The nano-hardness value of the film layer on the GG3 high-alumina silicon glass substrate was tested to be 20 GPa, and the Mohs hardness level of the film layer on the GG3 high-alumina silicon glass substrate was tested to be 4.

The coating on the GG3 high-alumina silicon glass substrate was tested with the abrasion resistance test using steel wool and did not pass the test (200-time test result: NG).

The coating on the GG3 high-alumina silicon glass substrate was tested with a cross-cut adhesion test, wherein small debris was observed at the intersection points of the cut lines, the peeled region was less than 5% of the total area, achieving a Level 1 according to GB/T 9286-2021, and the test failed.

The coating on the GG3 high-alumina silicon glass substrate and the coating on the PMMA/PC composite board plastic were conducted on durability testing. After 72 h high-temperature and high-humidity storage testing, 72 h temperature shock testing, and 48 h salt spray testing, the coatings exhibited a certain degree of peeling, and the test failed.

### Comparative Example 4

Comparative Example 4 provides a coating and a preparation method thereof. The chemical composition of the coating is Si_{0.35}N_{0.65}. The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples with a dimension of 20×20 mm into deionized water for ultrasonic cleaning for 15 min; and after drying with N₂, placing them into the vacuum chamber of the coating machine, and evacuating the vacuum chamber to 3×10⁻³ Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar and N₂ gases, setting the N₂ gas flow rate to 300 sccm, and setting the gas flow to maintain a gas flow ratio of Ar gas to N₂ gas of 0.67:1; maintaining the pressure inside the furnace at 0.36 Pa; setting the power density of the Si target to 2.4 W/cm², with a pulse duty cycle of 60%; and depositing the Si N protective coating. By controlling the film-forming time, the resulting film thickness was 520 nm.

The coating obtained by the above method was Si_{0.35}N_{0.65} and the silicon wafer was conducted on an FTIR spectroscopy, which shows that its FTIR peak position was 850 cm⁻¹, with a corresponding FWHM of 363 cm⁻¹. No hydrogen-related absorption peaks appeared at 3230˜3430 cm⁻¹, 2040˜2240 cm⁻¹, 1450˜1650 cm⁻¹, or 1050˜1250 cm⁻¹, indicating that the coating does not contain hydrogen.

The coating prepared in the Comparative Example 4 has a refractive index of 1.97 nm at 550 nm. The nano-hardness value of the film layer on the GG3 high-alumina silicon glass substrate was tested to be 18 GPa, and the Mohs hardness level of the film layer on the GG3 high-alumina silicon glass substrate was tested to be 3.

The coating on the GG3 high-alumina silicon glass substrate was tested with the abrasion resistance test using steel wool and did not pass the test (200-time test result: NG).

The coating on the GG3 high-alumina silicon glass substrate was tested with a cross-cut adhesion test, wherein small debris was observed at the intersection points of the cut lines, the peeled region was less than 5% of the total area, achieving a Level 1 according to GB/T 9286-2021, and the test failed.

The coating on the GG3 high-alumina silicon glass substrate and the coating on the PMMA/PC composite board plastic were conducted on durability testing. After 72 h high-temperature and high-humidity storage testing, 72 h temperature shock testing, and 48 h salt spray testing, the coatings exhibited a certain degree of peeling, and the test failed.

### Comparative Example 5

Comparative Example 5 provides a coating and a preparation method thereof. The chemical composition of the coating is Si_{0.55}N_{0.45}. The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples with a dimension of 20×20 mm into deionized water for ultrasonic cleaning for 15 min; and after drying with N₂ gas, placing them into the vacuum chamber of the coating machine, and evacuating the vacuum chamber to 3×10⁻³ Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar and N₂ gases, setting the N₂ gas flow rate to 24 sccm, and setting the gas flow to maintain a gas flow ratio of Ar gas to N₂ gas of 1.5:1; maintaining the pressure inside the furnace at 0.06 Pa; setting the power density of the Si target to 2.4 W/cm², with a pulse duty cycle of 60%; and depositing the Si N protective coating. By controlling the film-forming time, the resulting film thickness was 553 nm.

The coating obtained by the above method was Si_{0.55}N_{0.45} and the silicon wafer was conducted on an FTIR spectroscopy, which shows that its FTIR peak position exceeds the range of 838˜875 cm⁻¹, and the corresponding FWHM exceeds the range of 247˜313 cm⁻¹.

The coating prepared in the Comparative Example 5 has a refractive index greater than 2.2 nm at 550 nm. The nano-hardness value of the film layer on the GG3 high-alumina silicon glass substrate was tested to be 20 GPa, and the Mohs hardness level of the film layer on the GG3 high-alumina silicon glass substrate was tested to be 4.

The coating on the GG3 high-alumina silicon glass substrate was tested with the abrasion resistance test using steel wool and did not pass the test (200-time test result: NG).

The coating on the GG3 high-alumina silicon glass substrate was tested with a cross-cut adhesion test, wherein small debris was observed at the intersection points of the cut lines, the peeled region was less than 5% of the total area, achieving a Level 1 according to GB/T 9286-2021, and the test failed.

The coating on the GG3 high-alumina silicon glass substrate and the coating on the PMMA/PC composite board plastic were conducted on durability testing. After 72 h high-temperature and high-humidity storage testing, 72 h temperature shock testing, and 48 h salt spray testing, the coatings exhibited a certain degree of peeling, and the test failed.

### Comparative Example 6

Comparative Example 6 provides a coating and a preparation method thereof. The chemical composition of the coating is Si_{0.36}N_{0.64}. The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples with a dimension of 20×20 mm into deionized water for ultrasonic cleaning for 15 min; and after drying with N₂, placing them into the vacuum chamber of the coating machine, and evacuating the vacuum chamber to 3× 10-3 Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar—H₂ mixed gas and N₂ gas, setting the N₂ gas flow rate to 300 sccm, and setting the gas flow to maintain a gas flow ratio of Ar gas to N₂ gas ratio of 0.60:1, the gas flow ratio of H₂ gas to N₂ gas ratio of 0.07:1; maintaining the pressure inside the furnace at 0.36 Pa; setting the power density of the Si target to 2.4 W/cm², with a pulse duty cycle of 60%; and depositing the SiN:H protective coating. By controlling the film-forming time, the resulting film thickness was 250 nm.

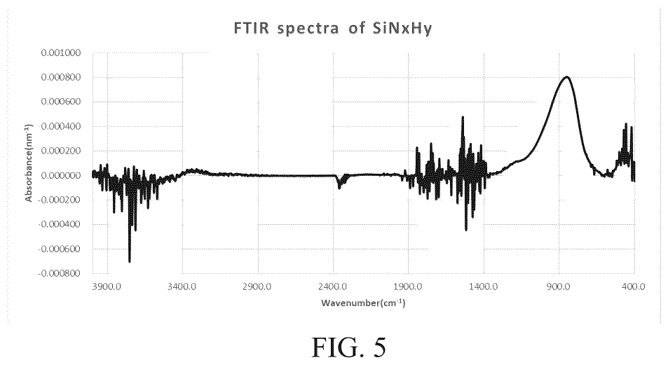

The coating obtained by the above method was Si_{0.36}N_{0.64} and the silicon wafer was conducted on an FTIR spectroscopy, which shows that, as shown in FIG. 5, the peak at 1167 cm⁻¹ in the FTIR spectrum corresponds to the bending vibration of the N—H bond, and the peak at 3306 cm⁻¹ corresponds to the stretching vibration of N—H, indicating that the coating contains hydrogen, with a hydrogen content>1% by the atomic percentage. In its FTIR spectrum, the peak position of the main absorption peak for the Si—N bond is 853 cm⁻¹, with an FWHM of 232 cm⁻¹.

The coating prepared in the Comparative Example 6 has a refractive index of 1.91 nm at 550 nm. The nano-hardness value of the film layer on the GG3 high-alumina silicon glass substrate was tested to be 18 GPa, and the Mohs hardness level of the film layer on the GG3 high-alumina silicon glass substrate was tested to be 3.

The coating on the GG3 high-alumina silicon glass substrate was tested with the abrasion resistance test using steel wool and did not pass the test (200-time test result: NG).

The coating on the GG3 high-alumina silicon glass substrate was tested with a cross-cut adhesion test, wherein small debris was observed at the intersection points of the cut lines, the peeled region was less than 5% of the total area, achieving a Level 1 according to GB/T 9286-2021, and the test failed.

The coating on the GG3 high-alumina silicon glass substrate and the coating on the PMMA/PC composite board plastic were conducted on durability testing. After 72 h high-temperature and high-humidity storage testing, 72 h temperature shock testing, and 48 h salt spray testing, the coatings exhibited a certain degree of peeling, and the test failed.

### Comparative Example 7

Comparative Example 7 provides a coating and a preparation method thereof. The chemical composition of the coating is Si_{0.36}N_{0.64}. The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples of with a dimension 20×20 mm into deionized water for ultrasonic cleaning for 15 min; and after drying with N₂, placing them into the vacuum chamber of the coating machine, and evacuating the vacuum chamber to 3×10⁻³ Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar and N₂ gases, setting the N₂ gas flow rate to 280 sccm, and setting the gas flow to maintain a gas flow ratio of Ar gas to N₂ gas of 0.67:1; maintaining the pressure inside the furnace at 0.36 Pa; setting the power density of the Si target to 2.4 W/cm², with a pulse duty cycle of 60%; and depositing the SiN protective coating, wherein by controlling the film-forming time, the resulting film thickness was 240 nm; then introducing Ar and C₂H₂ gases, setting the C₂H₂ gas flow rate to 400 sccm, setting the gas flow to maintain a gas flow ratio of Ar gas to C₂H₂ gas of 1:1; maintaining the gas pressure in the furnace at 0.8 Pa, setting the bias voltage duty cycle to 75%; and depositing the DLC coating, wherein by controlling the film-forming time, the resulting film thickness was 20 nm; and finally, using a resistance evaporation source, depositing a 20 nm fingerprint-resistant hydrophobic AF coating by controlling the deposition time.

In the protective obtained through the aforementioned method, the composition of the SiN layer is Si_{0.36} N_{0.64}; the water contact angle of the film layer on the GG3 high-alumina silicon glass substrate was tested to be 115°; the nano-hardness of the film layer on the GG3 high-alumina silicon glass substrate was tested to be 19 GPa, with a friction coefficient of 0.18; and the Mohs hardness level of the composite film layer on the GG3 high-alumina silicon glass substrate was tested to be 8.

The coating on the GG3 high-alumina silicon glass substrate was tested with the abrasion resistance test using steel wool and did not pass the test (3000-time test result: NG).

The coating on the GG3 high-alumina silicon glass substrate was tested with a cross-cut adhesion test, wherein small debris was observed at the intersection points of the cut lines, the peeled region was less than 5% of the total area, achieving a Level 1 according to GB/T 9286-2021, and the test failed.

The coating on the GG3 high-alumina silicon glass substrate and the coating on the PMMA/PC composite board plastic were conducted on durability testing. After 72 h high-temperature and high-humidity storage testing, 72 h temperature shock testing, and 48 h salt spray testing, the coatings exhibited a certain degree of peeling, and the test failed.

### Comparative Example 8

Comparative Example 8 provides a coating and a preparation method thereof. The chemical composition of the coating is Si_{0.44}N_{0.56}. The preparation method includes the following steps.

(1) Pretreatment: placing a GG3 high-alumina silicon glass with a dimension of 71×155 mm, a transmittance of T₄₀₀₋₇₀₀=92%, and a pencil hardness of 9H, an MB6001UR PMMA/PC composite board plastic with a pencil hardness of 3H, and silicon wafer samples with a dimension of 20×20 mm into deionized water for ultrasonic cleaning for 15 min; and after drying with N₂ gas, placing them into the vacuum chamber of the coating machine, and evacuating the vacuum chamber to 3× 10⁻³ Pa.

(2) Deposition of the protective coating: turning on the sample stage turntable, setting the rotation speed to 4 cycles per minute, adjusting the distance between the sample stage and the target surface to 10 cm, wherein the Si target is energized by a pulsed DC power supply; introducing Ar and N₂ gases, setting the N₂ flow rate to 240 sccm, and setting the gas flow to maintain a gas flow ratio of Ar to N₂ of 0.67:1; maintaining the pressure inside the furnace at 0.34 Pa; setting the power density of the Si target to 2.4 W/cm², with a pulse duty cycle of 60%; and depositing the SiN protective coating, wherein by controlling the film-forming time, the resulting film thickness was 731 nm; then introducing Ar and C₂H₂ gases, setting the C₂H₂ flow rate to 400 sccm, setting the gas flow to maintain a gas flow ratio of Ar gas to C₂H₂ gas of 1:1; maintaining the gas pressure in the furnace at 0.8 Pa, setting the bias voltage duty cycle to 75%; and depositing the DLC coating, wherein by controlling the film-forming time, the resulting film thickness was 20 nm; and finally, using a resistance evaporation source, depositing a 20 nm fingerprint-resistant hydrophobic AF coating by controlling the deposition time.

In the protective obtained through the aforementioned method, the composition of the SiN layer is Si_{0.44}N_{0.56}; the water contact angle of the film layer on the GG3 high-alumina silicon glass substrate was tested to be 116°; the nano-hardness of the film layer on the GG3 high-alumina silicon glass substrate was tested to be 18 GPa, with a friction coefficient of 0.19; and the Mohs hardness level of the composite film layer on the GG3 high-alumina silicon glass substrate was tested to be 8.

The coating on the GG3 high-alumina silicon glass substrate was tested with the abrasion resistance test using steel wool and did not pass the test (3000-time test result: NG).

The coating on the GG3 high-alumina silicon glass substrate was tested with a cross-cut adhesion test, wherein small debris was observed at the intersection points of the cut lines, the peeled region was less than 5% of the total area, achieving a Level 1 according to GB/T 9286-2021, and the test failed.

The film layer on the GG3 high-alumina silicon glass substrate and the film layer on the PMMA/PC composite board plastic were conducted on durability testing and passed 72 h high-temperature and high-humidity storage testing, 72 h temperature shock testing, and 48 h salt spray testing.

### Comparative Example 9

Comparative Example 9 refers to the method in the paper “Properties of Magnetron—Sputtered Silicon Nitride Films, T. Serikawa, et al, J. Electrochem. Soc., 131 (12): 2928-2933 to prepare SiN coatings. Specifically, reactive magnetron sputtering was used with a sputtering power of 3 kW, a substrate temperature of 200° C., a sputtering gas flow rate of 100 sccm, a nitrogen gas partial pressure of 0.28 Pa, and a total sputtering pressure of 0.56 Pa to obtain a coating with a N/Si atomic ratio of 1.42 (Si_{0.41} N_{0.59}). Analysis of the coating shows that the FTIR peak position was 840 cm⁻¹, with an FWHM of 370 cm⁻¹. The large FWHM indicates that the coating has high stress and is prone to cracking, with a refractive index of 1.97.

In the multifunctional protective coating of the present disclosure, for single-layer SiN coatings, the SiₓN_{y} coatings in Examples 1˜6 (where x and y are atomic ratios) satisfy: 0.39≤x≤0.43 and 0.57≤y≤0.61. Compared to Comparison Examples 1˜4, the coatings not only have a higher refractive index of 2.04˜2.13 at 550 nm, higher nano-hardness of 25˜30 GPa, and higher Mohs scratch hardness, but also have a narrower FWHM of 247˜313 cm⁻¹ in the peak position range of 838˜875 cm⁻¹. This indicates that the coatings are not only dense and hard but also have lower stress. When the SiN coating is used in multi-layer coating structures, it not only provides higher nano-hardness for the overall coating but also results in a lower friction coefficient for the overall coating, thereby achieving high scratch resistance for the multi-layer coating. In Comparison Examples 1˜4, the SiN coating components do not fall within the range defined in the present disclosure. The coatings have a refractive index of only 1.96˜1.97 at 550 nm, with lower nano-hardness of 19˜21 GPa and lower Mohs scratch hardness, possibly related to excessive Si or N content in the coating, insufficiently density in the coating structure, and higher stress in the coating. For multi-layer coating structures, compared to Comparison Examples 7˜8, Examples 7˜9 exhibit higher nano-hardness.

Finally, it should be noted that the above embodiments are only used to illustrate the technical solution of the present disclosure, and are not intended to be a limitation thereof. Notwithstanding the detailed description of the present disclosure with reference to the foregoing embodiments, it should be understood by those of ordinary skill in the art that one may still modify the technical solution described in the foregoing embodiments, or make equivalent substitutions for some or all of the technical features therein. These modifications or substitutions do not depart the essence of the corresponding technical solution from the scope of the technical solution of the embodiments of the present disclosure.

### INDUSTRIAL PRACTICALITY

The multifunctional protective coating of the present disclosure combines high refractive index, high nano-hardness, high scratch resistance, low stress, and high durability. The multifunctional protective coating of the present disclosure can be used as a protective coating for coated products. It can be used alone as the protective coating for coated products or in combination with other coatings to impart high refractive index, high nano-hardness, high scratch resistance, low stress, and high durability to the coated products.

1. A multifunctional protective coating, containing a material with a chemical formula SiₓN_{y}, wherein the material satisfies following characteristics:
(a) x and y are atomic ratios, with 0.39≤x≤0.43 and 0.57≤yb≤0.61;
(b) a full width at half maximum (FWHM) of a Fourier Transform Infrared (FTIR) spectrum at a peak position range of 838˜875 cm⁻¹ is 247˜313 cm⁻¹;
(c) a refractive index at 550 nm is 2.0˜2.2; and
(d) a hydrogen content, by the atomic percentage, is ≤1%.

2. The multifunctional protective coating according to claim 1, wherein the refractive index at 550 nm is 2.04˜2.13.

3. The multifunctional protective coating according to claim 1, comprising at least one of following characteristics:
(1) a nano-hardness of the coating ranges from 25-30 GPa; and
(2) a thickness of the coating is 0.01˜6.0 μm.

4. A preparation method of the multifunctional protective coating according to claim 1, comprising a following step:
depositing constituent elements of the multifunctional protective coating onto at least a portion of a surface of a substrate by a physical vapor deposition according to a predetermined ratio, to form the multifunctional protective coating.

5. The preparation method of the multifunctional protective coating according to claim 4, wherein under a condition of introducing a mixed gas of argon gas and a nitrogen-containing gas, a silicon target is used to form the multifunctional protective coating onto at least a portion of the surface of the substrate by sputter deposition.

6. The preparation method of the multifunctional protective coating according to claim 5, wherein the nitrogen-containing gas is the nitrogen gas, and a gas flow ratio of the argon gas to the nitrogen gas is (0.61˜0.71): 1.

7. The preparation method of the multifunctional protective coating according to claim 6, wherein the preparation method comprises at least one of following characteristics:
a sputter deposition temperature is 30˜330° C.;
a total gas pressure of the mixed gas is 0.05˜1.2 Pa;
a gas flow of the nitrogen gas is 56˜300 sccm;
a power density of the silicon target is 1.5˜2.4 W/cm²;
a bias voltage of the substrate is −180 to −20 V;
a sputter deposition time is 10˜300 min; and
a background pressure of a vacuum chamber used by the sputter deposition is ≤3.0×10⁻³ Pa.

8. A coated product, comprising a substrate and the multifunctional protective coating according to claim 1, wherein
the multifunctional protective coating is located on at least one side of the substrate.

9. The coated product according to claim 8, wherein the substrate is at least a bare piece, or a coated piece, of one of glass, plastic, and silicon.

10. The coated product according to claim 8, wherein the coated product further comprises a diamond-like carbon coating (DLC coating), or an Anti-Fingerprint coating (AF coating), or both.
